(19) United States
(12) Patent Application Publication
(10) Pub. No.: US 2022/0253958 A1
(43) Pub. Date: Aug. 11, 2022

(54) PROPERTY TOKEN BLOCKCHAIN SYSTEM AND METHOD OF USE

(71) Applicant: Consortia Corp., San Rafael, CA (US)

(72) Inventors: Teresa Grobecker, San Francisco, CA (US); Milo Sprague, San Francisco, CA (US); Claudio Ceballos Paz, San Francisco, CA (US)

(21) Appl. No.: 17/732,722

(22) Filed: Apr. 29, 2022

Related U.S. Application Data
(63) Continuation of application No. 16/365,249, filed on Mar. 26, 2019.
(60) Provisional application No. 62/648,029, filed on Mar. 26, 2018.

(51) Int. Cl. G06Q 50/16; G06Q 20/36; G06Q 50/00

(52) U.S. Cl. CPC G06Q 50/163; G06Q 50/01; G06Q 20/367

(57) ABSTRACT

A real estate data sharing system includes a distributed title ledger built on blockchain technology; the properties each having a unique identifier and being associated with a token representation on the distributed title ledger; and relationships tied to the token representation of each of the properties such that the relationships are recorded on the distributed title ledger; the distributed title ledger is an immutable record of the relationships tied to each of the pieces of real estate.

### BACKGROUND

### 1. Field of the Invention

The present invention relates generally to real estate data sharing, and more specifically, to a token blockchain system and method of use for recording and sharing data efficiently and effectively.

### 2. Description of Related Art

Real estate data sharing systems are well known in the art. For example, FIG. 1 depicts a flowchart 101 of a conventional method of data sharing. During use, data is collected and stored from one or more sources, the data all being stored in various locations and databases, as shown with boxes 103, 105. For example, there may be one database that includes information associated with liens on property, and another database associated with property information, such as photos and the like. As needed, the user, such as a broker, agent, or home owner, accesses the various databases for needed information, as shown with box 107.

One of the problems commonly associated with system 101 is inefficiency and ineffective transfer of data between users. For example, a user that is interested in purchasing a home, must either enlist the services of third parties to track down information, or they must spend considerable time tracking down the information on their own. This problem is further associated with other industries, wherein there are many parties that are interacting.

Accordingly, although great strides have been made in the area of data storage and sharing systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a flowchart of a common data storage and sharing system;

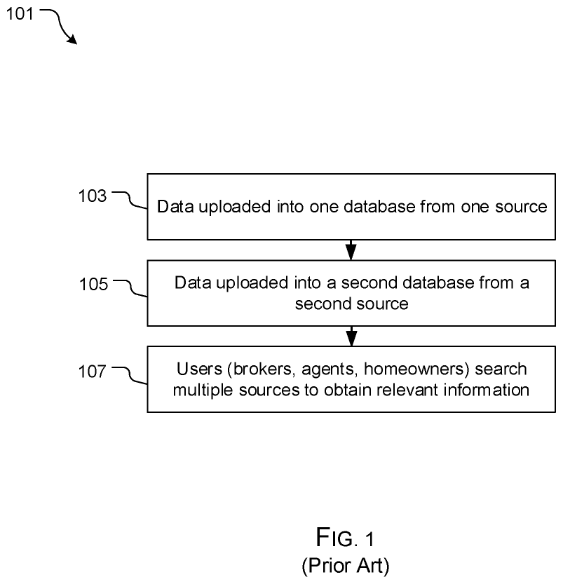

FIG. 2 is a simplified schematic of a property token blockchain system in accordance with a preferred embodiment of the present application;

FIG. 3 is a simplified schematic of data connected to tokens of each property in accordance with the present application;

FIG. 4 is a flowchart of a method of use of the system of FIG. 2;

FIG. 5 is a simplified schematic of a referral system associated with the system of FIG. 2 in accordance with the present application;

FIG. 6 is a flowchart of the method associated with FIG. 5; and

FIG. 7 is a simplified schematic of verifying data associated with a distributed title ledger of FIG. 2.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional data collection and sharing systems. Specifically, the present invention provides for a distributed title ledger that is configured to provide a means to share and update data from a plurality of sources. It should be appreciated that the system of the present invention is shown in reference to real estate, however, it should be appreciated that the system can be adapted for other industries. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

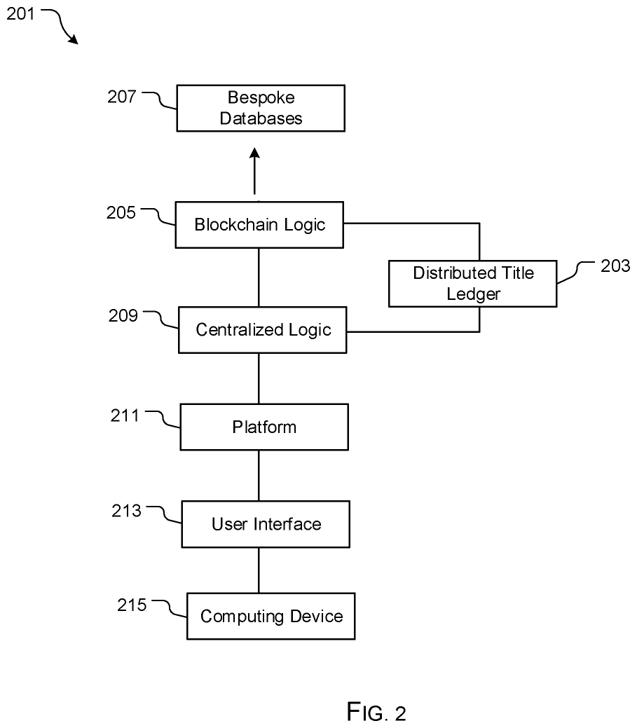

Referring now to the drawings wherein like reference characters identify corresponding or similar elements throughout the several views, FIG. 2 depicts a simplified schematic of a property token blockchain system 201 in accordance with a preferred embodiment of the present application. It will be appreciated that system 201 overcomes one or more of the above-listed problems commonly associated with conventional data sharing systems.

In the contemplated embodiment, system 201 includes a distributed title ledger (DLT) 203 with blockchain technology 205 and bespoke database technology 207. In the preferred embodiment, a centralized logic 209 is utilized to operate one or more business rules and other key technologies.

System 201 further includes a platform 211 that functions as a user interface 213 and can be accessible via one or more computing devices 215, such as smart phones, tablets, or the like. The platform 211 can be a mobile platform that allows a user to update the DLT, view data on the DLT, and the like.

It should be appreciated that one of the unique features believed characteristic of the present application is the utilization of the distributed title ledger 203 to receive and store data associated with a plurality of properties that allows for each party involved in a transaction, such as a sale, to have access to needed information. This system can be utilized with every property in the United States and internationally. It should further be appreciated that this system can be applied to other industries, such as any company that makes referrals to professionals and/or companies that have relationships with service providers such as lenders, debt holders, equity claims, etc.

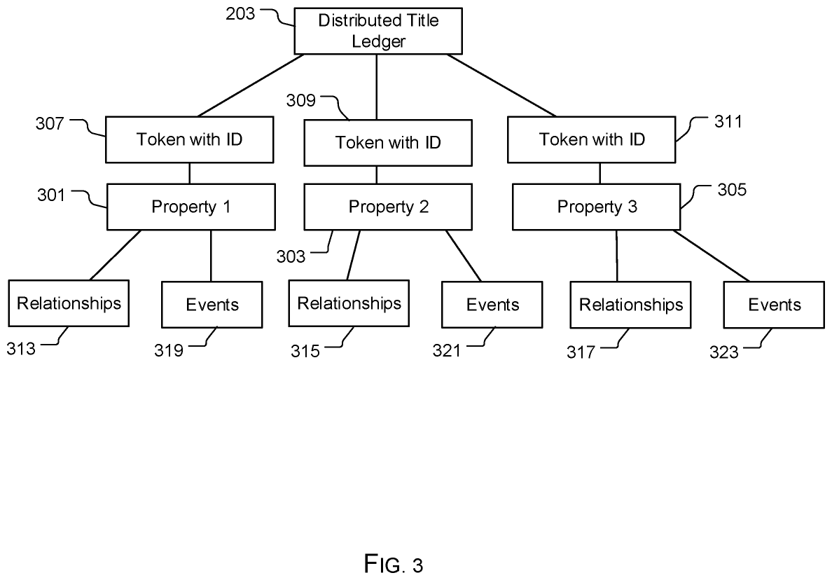

As shown in FIG. 3, in one embodiment, it is contemplated that each of a plurality of pieces of property 301, 303, 305 is assigned a token with a unique ID 307, 309, 311. In some embodiments, the token could have a currency or monetary value assigned to it. This token is tracked within the DLT, to be updated and retrieved as needed by users. As shown, the token for each property is updated with one or more relationships 313, 315.317 and one or more events 319, 321, 323. In some embodiments, the token merely includes a legal description (such as address. APN, geo location), identifies the owner, and also identifiers any liens on the property. However, as will be discussed, more data and information about properties can be used.

It should be appreciated that the property relationships can be any data that is relevant to the property. This can include one or more of: (1) claims on title, liens, valuations, taxes, encumbrances, changes to the legal or physical description of the property, improvements, documents, contracts; (2) all legal documentation related to the property, such as sale contracts, construction, permits, easements; (3) real estate agent and broker referrals associated with either the buyer or seller of real property; (4) notification of relationships and relationship changes to property owner and stakeholders, including any relevant documents; (5) one or more unique identifiers based on street address, county. APN, latitude and longitude; (6) a registry lookup portal of unique identifiers; (7) verification of property owners and/or stakeholders; (8) visual representations (photos/videos) of the property; and (9) any other characteristics of the property, such as lot size, lop parameters, rooms, floors, provenances, etc.

It should further be appreciated that the one or more events can be data that relates to any event associated with the property, such as: (1) the collection of tax; (2) the collection of rent; (3) payment settlement of referrals and real estate sales; (4) revenue and referral payments; (5) tracking real estate referrals between referring real estate agents; (6) the completion of appraisals; (7) tracking of property scores based on provenance history; (8) the verification of property title history; (9) validation of distributed ledger for stakeholders to verify provenance and claims on title; and (10) the transfer of title ownership either between owners on the platform of the present invention or on public exchanges.

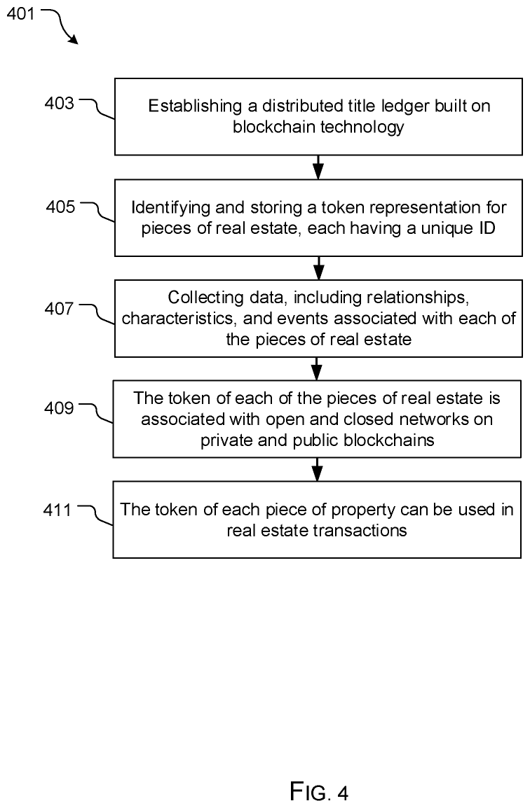

In FIG. 4, a flowchart 401 depicts the method of system 201. During use, the distributed title ledger built on blockchain technology is established to hold a title token for each property, as shown with box 403. A plurality of pieces of property, such as all property in the United States, are assigned a token and a unique ID, as shown with box 405. Data is collected from a plurality of sources, some public and some private, wherein all of the data is stored in connection with the token of the associated property, as shown with box 407. The token of each of the pieces of real estate is associated with open and closed networks on private and public blockchains, as shown with box 409. The token of each of the pieces of property can then be used in any real estate transaction, as shown with box 411.

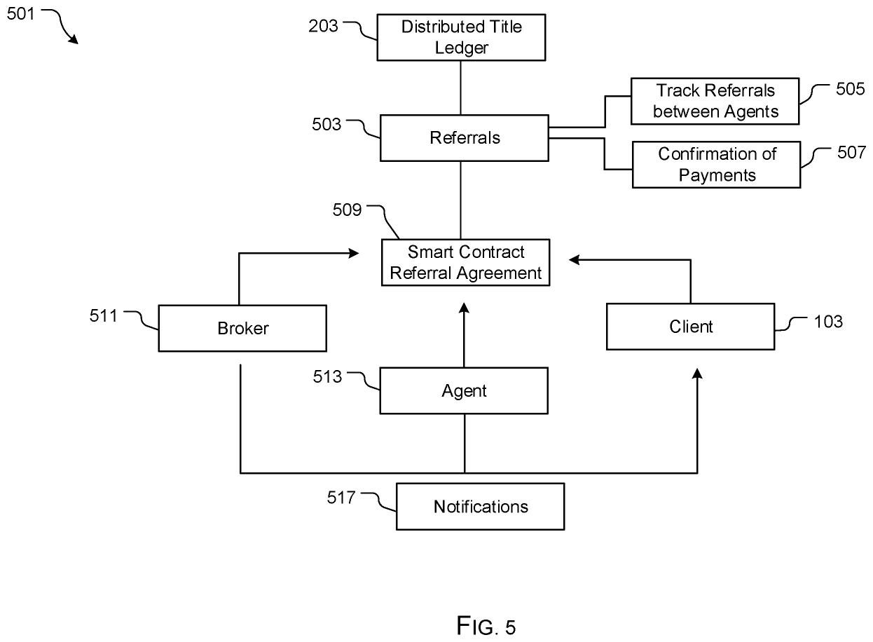

In FIG. 5, a simplified schematic specifically depicts a referral system 501 associated with the distributed title ledger 203 of the present invention. The system allows for the tracking of all data associated with referrals 503, such as the tracking of referrals between agents 505 and the confirmation of referral payments 507. This system allows for the creation of one or more contracts 509 between associated parties, including one or more brokers 511, one or more agents 513, and one or more clients 515. It should further be appreciated that notifications 517 of referrals can be provided to clients.

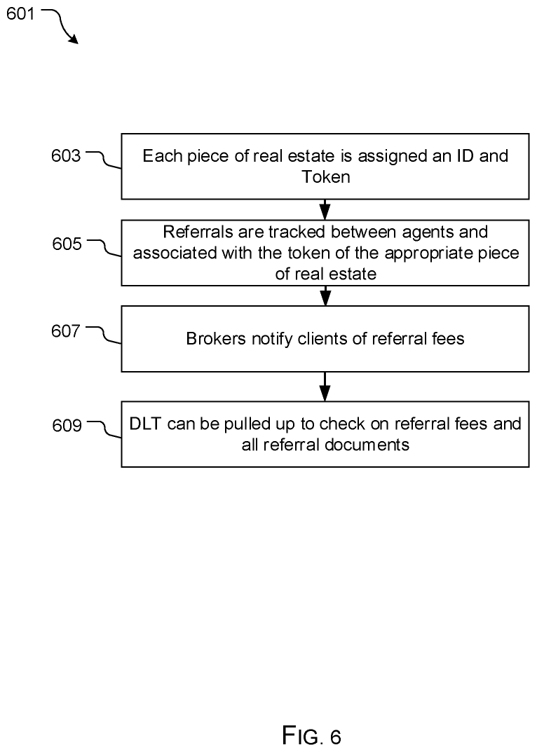

In FIG. 6, a flowchart 601 depicts a method associated with the referral system 501. During use, each piece of real estate is first assigned a token with a unique ID, as shown with box 603. Referrals are tracked between agents and associated with the token of the appropriate piece of real estate, as shown with box 605. Brokers can notify clients of referral fees, as shown with box 607, and all associated data and documents are tracked with the DLT to be checked as needed, as shown with box 609.

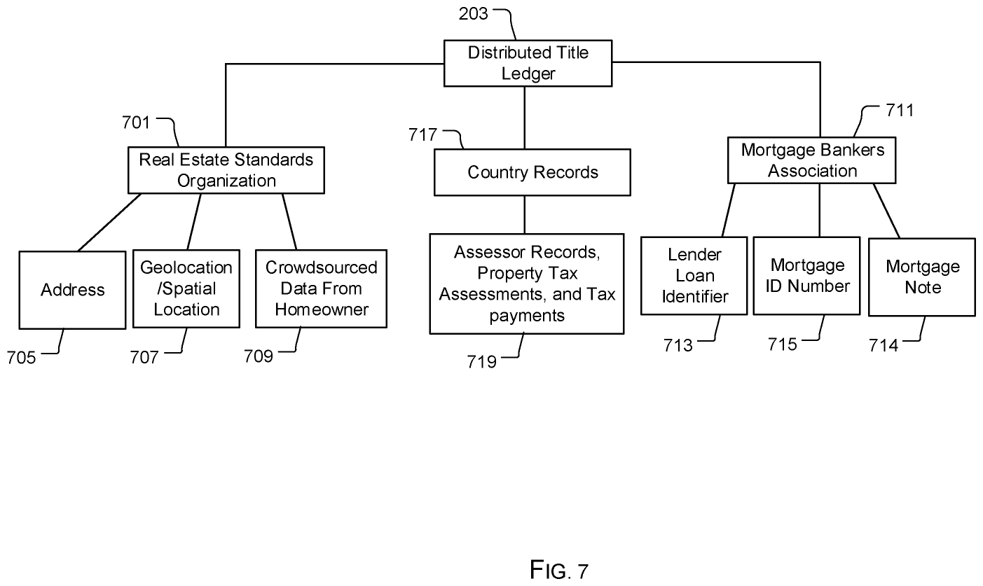

In FIG. 7, a simplified schematic depicts the verification of data as associated with the distributed title ledger 203. It should be appreciated that the system of the present invention provides a means for the various parties to ensure validity. As shown, data includes data from the real estate standards organization 701, an address 705, a geolocation/spatial location 707, and crowdsourced data from the homeowner 709. Additional data can include mortgage bankers association data 711, such as lender loan identifier 713, a mortgage ID number 715, and mortgage note information 714, including mortgage note information from the borrower and note holder and payment history. In addition, data from county records offices 717 can be obtained, including assessor records, property tax assessments, and tax payments 719.

In some embodiments, the token will be built on Ethereum platforms, however, it is contemplated that any blockchain platform could be used. In addition, in some embodiments, the token will be compatible using ERC20 and ERC721.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A real estate data sharing method, comprising:
providing a distributed title ledger built on blockchain technology;
storing a token representation for a plurality of pieces of real estate, wherein the token representation of each of the plurality of pieces of real estate is associated with a unique identifier;
saving a plurality of relationships tied to each of the plurality of pieces of real estate, the plurality of relationships being tied to the token representation of each of the plurality of pieces of real estate;
wherein the distributed title ledger is an immutable record of the plurality of relationships tied to each of the plurality of pieces of real estate.

2. The method of claim 1, further comprising:
recording one or more events tied to each of the plurality of pieces of real estate and associating the one or more events with the token representation of each of the pieces of real estate.

3. The method of claim 1, further comprising:
utilizing bespoke technology in the providing of the distributed title ledger.

4. The method of claim 1, wherein the saving of the plurality of relationships further comprises:
recording one or more referrals associated with each of the plurality of pieces of real estate.

5. The method of claim 1, wherein the saving of the plurality of relationships further comprises:
saving a legal description, an identity of a current owner, a listing of liens associated with each of the plurality of pieces of real estate.

6. The method of claim 1, wherein the saving of the plurality of relationships further comprises:
taking one or more visual representations of each of the plurality of pieces of real estate; and
saving the one or more visual representations to be associated with the token representation of each of the plurality of pieces of real estate.

7. The method of claim 1, further comprising:
providing a mobile application configured to provide access to the distributed title ledger.

8. A real estate data sharing system, comprising:
a distributed title ledger built on blockchain technology;
a plurality of properties each having a unique identifier and being associated with a token representation on the distributed title ledger; and
a plurality of relationships tied to the token representation of each of the plurality of properties such that the plurality of relationships are recorded on the distributed title ledger;
wherein the distributed title ledger is an immutable record of the plurality of relationships tied to each of the plurality of pieces of real estate.

9. The system of claim 8, further comprising:
one or more events tied to each of the token representations of each of the plurality of properties.

10. The system of claim 8, wherein the distributed title ledger utilizes bespoke technology.

11. The system of claim 8, wherein the plurality of relationships includes a record of one or more referrals associated with each of the plurality of properties.

12. The system of claim 8, wherein the plurality of relationships includes a legal description, an identity of a current owner, a listing of liens associated with each of the plurality of pieces of real estate.

13. The system of claim 8, further comprising:
one or more visual representations associated with each of the plurality of properties, wherein the one or more visual representations are recorded within the plurality of relationships associated with each of the plurality of properties.

14. The system of claim 8, further comprising:
a mobile application configured to provide access to the distributed title ledger.
